(19) United States
(12) Patent Application Publication
(10) Pub. No.: US 2007/0162292 A1
(43) Pub. Date: Jul. 12, 2007

(54) System and method for negotiating retailer access to consumer-owned content via negotiated electronic agreements in a retail environment

(75) Inventors: Kevin H. Bell, Raleigh, NC (US); Nathan Colgate Clark, Castro Valley, CA (US); Boyd King Dimmock, Raleigh, NC (US); John Smith Graham, Raleigh, NC (US); James Louis Griesedieck, Raleigh, NC (US); Ameet Anil Kulkarni, Woburn, MA (US); Krishna Prasad, Cary, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/329,256

(22) Filed: Jan. 10, 2006

(51) Int. Cl. G06Q 99/00; G06F 9/44; G07G 1/00; G07G 1/14

(52) U.S. Cl. 705/1; 705/7; 705/10; 705/14

(57) ABSTRACT

A consumer maintains control of certain personal information via the consumer's decision to create, store and offer a retailer conditional access to certain portions of the consumer's identifying information. The consumer is able to set individualized conditions of how access may be acquired and in view of what exchange or offers the consumer wishes to see from the retailer. Upon the retailer's agreement to such conditions, a retailer may be provided access to certain portions of the consumer's identifying information. The retailer and consumer may also enter into an electronic negotiation if there is initial disagreement as to preferred terms in order to adequately value and assess one another's offers in view of the exchange. In so doing, a retailer is able to gain information and characteristics of retail activity from the consumer, and a consumer is able to be rewarded from the retailer for the value of the information provided.

### FIELD OF THE INVENTION

The present invention relates to a system and method for providing, collecting, and receiving consumer-owned identifying information and negotiating access thereto with a retailer.

### BACKGROUND OF THE INVENTION

Consumers have become quite familiar with the use of electronic data collection systems in the retail environment which may employ the use of collecting shopping histories, counting coupon usage, and even discounting the pricing of items in exchange for a consumer using a retailer's incentives (i.e., loyalty card, contest, etc.) or purchasing certain types of goods offered by a particular manufacturer. Consumers have also become quite familiar with the use of electronic financial systems involving a diversity of debt medium, such as credit cards, debit cards, and electronic financial checks, and have become accustomed to their use in the general retail environment, physically and remotely.

The consumers' familiarity with these systems has proven quite important operationally and in building trust with consumers as consumers transact with retailers in remote environments (i.e., internet and e-commerce transactions) or even across an expanded geography. In essence, the continued and seemingly routine use and familiarity of consumers with the electronic data collections systems and electronic financial systems actually facilitates retail purchases across geographic distances, including across varied electronic communication methods such as the telephone system and the Internet.

One unforeseen result of such familiarity is that many consumers may now believe that the data collected, analyzed and used by the retailers and manufacturers (i.e., data such as shopping histories, frequency of certain product purchases, type of electronic payment used, etc.) is overreaching or undervalued. Certainly, certain consumers are desirous of maintaining at least a limited anonymity when making purchases in a retail environment while other consumers may assess that they would be willing to share certain of their personal information in exchange for a better or improved opportunity in the retail environment.

Today, consumers have made certain concessions in their sharing of personal information for ease of use or limited discounting. For instance, a consumer may readily review or view a limited amount of their previous transaction history over an on-line display offered through a retailer or even a credit card entity. As another example, a consumer may receive coupons or discounts from manufacturers and retailers based upon the sharing of that consumer's shopping history with the manufacturer or retailer. Further a frequent consumer may be entitled to a special incentive award for their purchases over a specific period of time or based upon the type of purchase made (e.g., holiday festival offerings). However, individual consumers are only able to unilaterally share their data with a receiving retailer or manufacturer based upon the receiving retailer's or manufacturer's terms for all consumers, independent of each consumer's unique position or profile, and only in the situation where the consumer is wholly accepting of those terms without comment, modification or negotiation. Often therefore, a consumer may wish to limit the consumer's private information to another party's access or even suggest electronically certain terms of which may be acceptable to provide another party with access to certain of the consumer's information that the consumer defines as being private.

Retailers have also become quite familiar with the use of electronic data collection systems and electronic financial systems, where most all retailers now employ some form of such systems in their daily operation. However, similar to consumers, retailers are beginning to realize that their process of collection of consumer data and their evaluation of the value of consumer data to be collected is not an individualized process; instead their process and evaluation captures common consumer data from consumers who may have more personal data to offer, of undetermined and unassessed value. Additionally, the consumer data collected by retailers is often limited to the data that the retailer alone has captured, and is devoid of competitive or environmental data that could readily be recognized as useful information by the retailer. Often therefore, a retailer may wish to seek additional or less information from a consumer based upon certain characteristics of that consumer or that consumer's activity, even suggest electronically certain incentives or real-time offers which may be of interest to the consumer in exchange for certain information.

Consequently, a significant need exists for a system and method whereby consumers may control the access to and definition of their consumer identifying information (CII) at varying levels and retailers may also seek to interactively gather CII, at varying levels, from consumers, when and if permitted by consumers.

As used herein, Consumer Identifying Information (CII) is not limited to only data or information that uniquely identifies a particular consumer, but rather the CII is inclusive of data and information that identifies the consumer, consumer characteristics (including but not limited to personal information, purchasing trends, product interests, future interests, incentives activities, etc.), and/or the acts of the consumer in the retail environment (shopping histories, advertising interests, etc.). CII is also inclusive of personal interests of the consumer such as relatives' birthdays, shopping patterns, timing of decisions, shopping activities by retailer, etc., wherein most any of the CII information may be generated in a variety of manners using new methodologies or those that may be generated by known methods including manually creating lists and profiles on a computer or generating consumer purchasing histories through loyalty programs.

### SUMMARY OF THE INVENTION

The present invention addresses these needs as well as others with a consumer local media device that determines the provision of access of one or more selected subsets of consumer identifying information to a retailer, wherein access to one or more of the subsets is determined by access gate criteria set forth by the consumer.

A focus of the invention is to provide a method for a retailer permissively influencing one or more shopping decisions of a consumer in a retail environment in cooperative exchange, comprising: setting forth consumer identifying information characteristics on a local consumer media device (such as a PDA or Smartcard); storing a predetermined subset of said characteristics on media of said local consumer media device; communicating a conditional availability to access said subset to a retailer via an electronic communications means (such as the wireless import/export apparatus of a PDA), wherein said conditional availability is offered by said consumer under a set of access rules prior to communicating the subset; and negotiating to accept or reject access of said subset in relation to retailer's response and said access rules.

A further focus of the invention is to provide a method for negotiating an electronic agreement between a retailer and a consumer having a local consumer media device with consumer information stored on media therein, for a retailer's access to a predetermined set of consumer identifying information, the method comprising: electronically creating and storing on media of said local consumer media device consumer identifying information of the consumer; electronically creating and storing on said local consumer media device a first subset of predetermined consumer identifying information of the consumer; electronically associating said first subset of predetermined consumer identifying information with electronic permission terms, having negotiated offers of interest for consumer, for accessing said subset; and offering said subset to said retailer by communicating said permission terms for said retailer's acceptance or rejection; providing said retailer access to said subset where said retailer accepted said permission terms; and providing said consumer, via said local consumer media device, negotiated offers of interest as negotiated.

A further focus of the invention is to provide a system for electronically negotiating an electronic agreement between a retailer and a consumer for a retailer's access to a predetermined set of consumer identifying information, comprising: a networked computer of a retailer, a local consumer media device capable of communication with a networked computer of retailer, a means for communication and sharing of data as between said local consumer media device and said networked computer of said retailer, using the methods set forth hereinunder.

In accordance with the invention as defined in the claims, it is an object of the present invention to enable a retailer to gain information and characteristics of retail activity from the consumer, and enable a consumer to be rewarded by the retailer on negotiated terms for the value of the information provided.

The above and other highlights and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with a general description of the invention given above, and the detailed description of the embodiments given below, serve to explain the principles of the invention. Other aspects, features, and advantages of the present invention will become more fully apparent from the following detailed description, the appended claims, and the accompanying drawings in which:

FIG. 1 illustrates a data structure for the local consumer media of a consumer media device in accordance with an embodiment of the present invention;

FIG. 2 illustrates a generalized block structure of the local consumer media device in communication in a retail environment initiating retail transaction activity, in accordance with an embodiment of the present invention; and,

FIG. 3 is a flowchart of a sequence of operations for transaction communication between a consumer and a retailer, using a computer system such as that as the system of FIG. 2 of the present invention, in accordance with an embodiment thereof.

### DETAILED DESCRIPTION

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings.

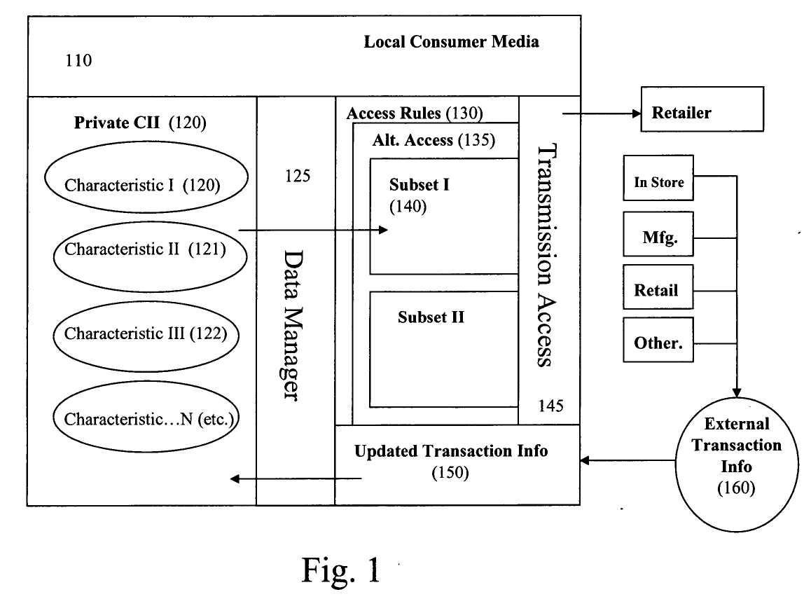

FIG. 1 illustrates a data structure 100 for the local consumer media 110 in accordance with an embodiment of the present invention.

The local consumer media 110 is a consumer media device and preferably smart media or local storage within a consumer's personal digital assistant (PDA). However, the local consumer media is not intended to be limited to such. The local consumer media may be media of any consumer media device such as a smart card memory, memory stick, flash memory, hard drive, which is operable on a programmable device such as a PDA, cell phone, laptop or similar device. It may be any storage medium or device having a storage medium that is capable of storing the consumer identifying information (also used herein as “consumer profile”) in one or more forms locally for the consumer. Additionally, a remote consumer media device, not pictured, may include a laptop or desktop computer at a consumer's residence, by way of example, where the local consumer profile stored on the local consumer media is remotely stored, modified and updated by the consumer.

The local consumer media comprises consumer identifying information which is preferably contained in a key encrypted private profile control record labeled in FIG. 1 as “Private CII” at 120. In a preferred embodiment, the key encrypted private profile control record may be accessed by the consumer through encryption keys, passwords, key combinations or other similar access-restrictive means, and it is the intent of the consumer to secure the information in whole in the Private CII and shield access to such from any third parties.

The Private CII contains all data files that a consumer has created with respect to his shopping interests and may, preferably, also contain files that he has negotiated and recorded through his retail transactions. For instance, in one embodiment of the present invention, at 121, the Private CII would likely contain directly identifying personal information such as a consumer's name, address, financial information and/or credit card information, telephone number, and other similar identifying personal information. Additionally, the Private CII would likely contain consumer transaction information at 122 such as a consumer's shopping history (preferably recorded from a retail transaction or as edited by a consumer directly), a consumer's preferences for certain kinds of products, a list of retailers used by the consumer and the respective shopping histories associated therewith, pricing of certain products across varied retailers used by the consumer, and a consumer's present shopping list.

Further, the Private CII would likely also contain consumer interests information, at 123, such as electronic coupon information received and used, rebate and incentive programs the consumer is a part of, promotional incentives the consumer has participated in, birthday information of relations or friends, and contact information of consumer affiliates (e.g., phone numbers of neighbors or names of members of a local sports team). For the avoidance of doubt, the consumer is not intended to be restricted in providing or organizing data about himself, his retail activities or his interests such that the information set forth in the Private CII may be all inclusive or specifically limited to data that the consumer sets forth.

The consumer is able to create and modify his Private CII and using a data manager application at 125, the consumer is able to create and modify at least one Public Accessible CII Subset, at 140, in relation to a set of accessibility rules, at 130, that the consumer defines. The consumer may also set forth a tiered set of alternate access rules, at 135, which would allow a consumer to negotiate iteratively with a retailer without having the need to manually assess each offer of a retailer. The Public Accessible CII Subset is a profile record of certain select data of the Private CII that the consumer elects to have made available to others upon the agreement to certain rules that the consumer sets forth in the accessibility rule set in respect to the Subset of interest. The Public Accessible CII Subset (also used herein as “Subset”) is intended to be a data storage area of the local consumer media (or consumer device) that is generally accessible to a computer program running on any number of devices in any particular retail environment, such as that of a Point of Sale (POS) system, a kiosk, personal shopping assistant, self checkout (SCO) system, a workstation or computer.

In a preferred embodiment, the local consumer media is resident on a PDA and the consumer has elected to maintain an “active transmit” capability, at 145, on his PDA whereby the PDA is openly transmitting the existence of a Subset in an attempt to attract a retailer who may have an interest in negotiating for access to the Subset and thereafter acquiring access to the data of the Subset.

Additionally, by way of example, in a preferred embodiment, where the consumer elected to have two Subsets, one for shopping histories and one for retailer pricing data, the consumer may wish to cause a retailer to have relatively simple access with limited rule restrictions for the shopping histories collected; however, that same consumer may wish to have more restrictive rules in existence around the retailer pricing data as the consumer may perceive this competitive data to be of greater value to the retailer or may not wish to share such data with certain retailers. A retailer's computer program would be able to recognize the existence of two Subsets but not be able to determine the contents of either Subset until the retailer was able to fully comply with the rules of accessibility to each respective Subset.

For any of the aforementioned Private CII or the Subsets, it is the intention of the present invention that consumer maintains control over and ownership of the data that resides in the local consumer media and is able to negotiate with third parties who are desirous of access to such data. The terms of access and the content of the data therein is intended to be able to be readily created, modified and updated by the consumer using various devices which enable data creation, modification and/or updates.

The local consumer media 100 may also be updated by receiving new information from retailers in response to negotiated access, transaction activity, incentive and promotional consideration and the like (also used herein as “Updated Transaction Information”). Updated Transaction Information is communicated to the local consumer media through traditional communication devices and mediums, and such Updated Transaction Information is stored locally on the local consumer media device in a non-private but access protected portion of the local consumer media, at 150. Updated Transaction Data may include data of unlimited types which are presented to the consumer in response to the negotiated access and such data may come from Manufacturers, Retailers, on-line promotions or the like, at 160. At a later time, a consumer migrates the information in the Updated Transaction Data into the Private CII, the remote consumer media and/or share select portions of the Updated Transaction Data with one or more predetermined Subsets.

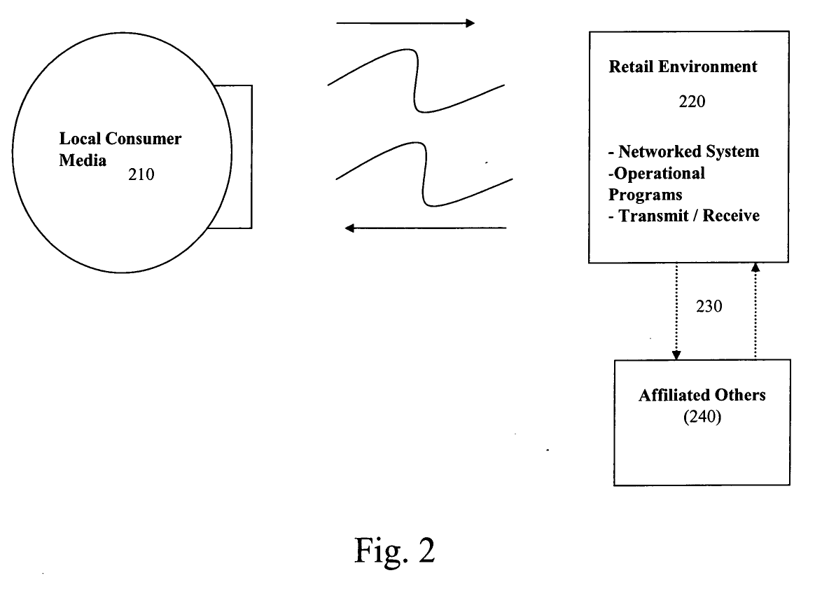

FIG. 2 illustrates a generalized block structure 200 of the local consumer media 210 in communication in a retail environment 220 initiating retail transaction activity, in accordance with an embodiment of the present invention.

The local consumer media 210 may be used in a computer application and or communication device as previously set forth hereinabove. Preferably, the local consumer media 210 either initiates or is in communication with a network 220 or programs operating at the retail environment upon the entrance of the consumer with the local consumer media into the retail environment. The communications network 220 may represent practically any type of networked interconnection, including but not limited to local-area, wide-area, wireless, and public networks (e.g., the Internet), and is, in a preferred embodiment, the network of a retailer of which a retailer's server is configured to.

In a preferred embodiment, the communications network includes a kiosk for receiving a consumer's local consumer media. The consumer may place his local consumer media in communications with the retailer's kiosk to negotiate with the retailer and determine if the retailer is accepting of the consumer's access rules for his one or more Subsets. The retailer may use the opportunity at the kiosk to display information graphically, such as the acceptance of terms, or may promote other information to the consumer at such time. In the event the negotiation is successful, the kiosk will download the information of the Subset of the consumer to the retailer's network and then update the consumer's Updated Transaction Information at a future session in the store (e.g., at checkout later in the same visit, at a promotional kiosk in the store, or on another visit). The retailer, depending on the negotiated terms with the consumer, may then elect to share the information obtained from the Subset of the consumer with others 240 such as its suppliers, manufacturers, distributors, affiliates and the like through other networked communications means 230.

In operation, prior to or upon the entrance to the retail environment a consumer may choose to allow the retailer access to the Subset data upon certain limited terms. These terms are determined and defined exclusively by the consumer and are inclusive of terms where there is no restriction to access as well. The consumer may provide this access to retailer manually, via personal codes, or automatically under program control that is dependent on the satisfaction and agreement by the retailer to certain predetermined access rules.

In one instance, by way of example, the consumer is in communication with the retailer's kiosk device having placed the local consumer media therein such that the retailer's kiosk instantiates a program to query the consumer via the local consumer media to determine the interest and rules of access from the consumer. The retailer has determined that the consumer is interested in sharing the data of a Subset in exchange for a 10% discount on any purchase made in the store today. The retailer assesses the viability of the negotiated offer and determines, using its own discretion and evaluation criteria, whether to accept or offer a counter offer to the consumer. Whenever a positive acceptance is received by one party from the other, a transaction event occurs and access to the Subset is provided.

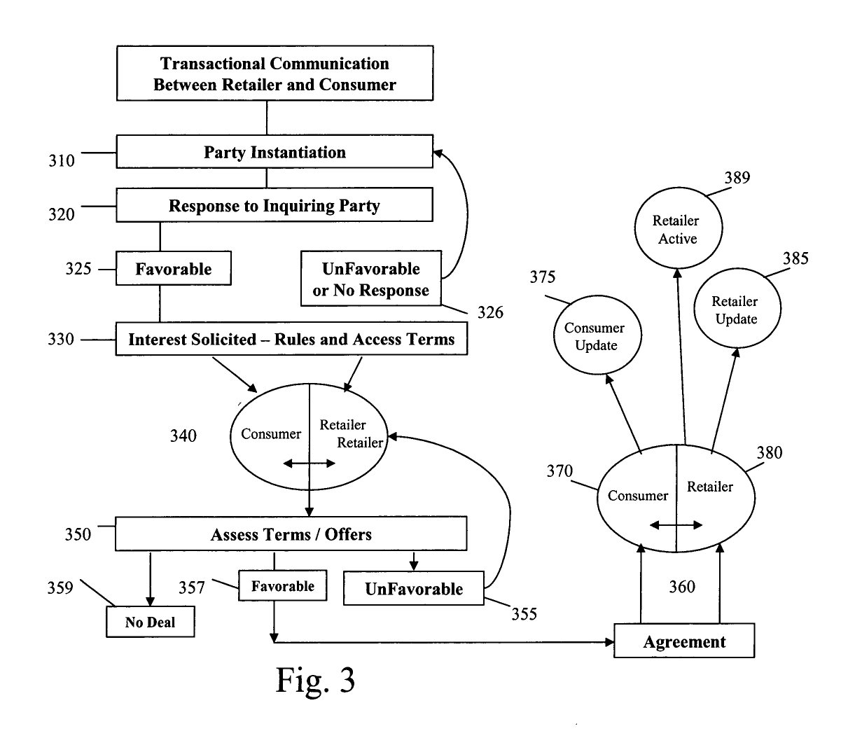

FIG. 3 is a flowchart 300 of a sequence of operations for transaction communication between a consumer and a retailer, using a computer system such as that as the system of FIG. 2 of the present invention, in accordance with an embodiment thereof.

In FIG. 3, either a consumer or a retailer may initiate the inquiry of the other as to their interest in engaging in a transaction in which there is a bargained for exchange as between the two parties. At 310, either the consumer or the retailer seeks to engage the other. At 320, a response is transmitted to the inquiring party as to interest, and the response may also be inclusive of terms of engagement. Alternatively, an initial interest response may be communicated to the inquiring party and the accepting party may wait and see what interests or offers the inquiring party wishes to first make before setting forth its terms for further inquiry. If the response is favorable, at 325, the parties shall further communicate; in the event the response is not favorable, at 326, the inquiring party may elect to re-inquire or to no longer engage with the other party.

In the event of a favorable response, one or both of the parties may solicit or offer to the other party interest or rules for access to the other parties data or offerings, at 330. For instance, a consumer having agreed to receive further inquiry from a retailer, may respond to the retailer that certain Subset data is available for sharing but only in exchange for certain promotional or value considerations during that consumer's shopping experience. In other example, a retailer may further inquire of a consumer that it will provide a blanket discount on that consumer's purchases today provided that the consumer provide open access to all data in its Subsets. The negotiation and terms of negotiations may be manual, automatic or interactive, depending on the consumer and the network.

At 340, there is an exchange of access rules from the consumer and an offering from the retailer. Each of the parties assesses its interest in lieu of the offer before it and either agrees or disagrees, at 350. At 355, the parties do not agree but continue the exchange until a set of terms can be agreed upon at 357 or no terms can be agreed to at 359. At 358, the parties have come to agreement on the terms. Having agreed to the terms of one another, the negotiated arrangement is deemed executed and the processes of each party's networks and media undertake the steps necessary to execute the terms of the arrangement.

At 360, a series of activities between the parties may occur concurrently, serially or independently, and may not be the only exclusive activities undertaken by the parties based upon the terms of the arrangement. For instance, at 370, the consumer is provided the negotiated arrangement from the retailer's network and the consumer, via his media or network, stores and/or records the receipt of the negotiated arrangement and the respective incentive offerings or other negotiated contributions (e.g., discounts, coupons, data exchanges, etc.) from the retailer. Similarly at 380, the retailer is provided the negotiated arrangement from the consumer's local media and then the retailer, via its network, stores and/or records the receipt of the negotiated arrangement and the respective data from the specific Subset or other negotiated contributions (e.g., shopping histories, certain other consumer identifying information, etc.) from the consumer.

At 375, the consumer is then able to update its local media and associated Private CII files to the extent the consumer may desire. Similarly, the consumer may then update the remote locations of its Private CII and other associated files.

At 385, the retailer, dependent upon the actual negotiated terms, is then able to update its file histories and associations with consumer information, product information, manufacturer databases, local databases and other associated information collection aspects of interest to the retailer. Similarly, the retailer may then elect to undertake additional analytical efforts on the collected data individually, in combination with other collected data, and similar.

At 389 the retailer may also maintain an active status for the present consumer to ensure that additional transactions undertaken while on a common or similar visit at the retailer are captured under the same negotiated arrangement terms. In a preferred embodiment, a retailer may negotiate the arrangement with the consumer upon the consumer entry into the retail environment, provide varied offers in addition or as part of the negotiated arrangement to the consumer as the consumer traverses the retail environment, provide incentives or other product induced offerings in view of real-time shopping activities of the consumer in the retail environment, and provide a final set of offerings or return incentives to the consumer at the time of final checkout.

In another preferred embodiment of the present invention, whenever a consumer purchases a unique product or appears to undertake an activity with a special purposes (e.g., the purchase of a birthday cake), the retailer may elect to store that purchase information, inclusive of dates, on the consumer profile that has been negotiated. On a return visit to the retail environment and where the consumer and retailer have a continued or new negotiated arrangement allowing for the sharing of data, historical data previously captured by the retailer may be used to authenticate the consumer, update information previously captured by the retailer, and remind the consumer of prior important dates where present or planned shopping lists of the consumer do not reflect past activity. The collection of data over a period of time allows the retailer to identify patterns that may be useful to remind the consumer of oversights in preparing a current shopping list and also to identify special opportunities, such as promotions that may be of interest. It is intended that a resulting arrangement from the present invention is that the shopping experience of the consumer can be enhanced and the retailer can maintain a long-lasting, mutually beneficial relationship with the consumer.

In another preferred embodiment of the present invention, a consumer may download electronic coupons onto the local consumer media from various manufacturers and/or other electronic discount sources, including the in-store or retail campaigns active while shopping. The data structure of the present invention provides that such promotions, coupons and the like may be represented to the consumer graphically and in list format. Similarly the triggering event enabling the selection of which coupons to show or offer to the consumer may be negotiated or based upon products selected by the consumer or similar triggering events, provided such matters are defaulted or resolved as between the parties in the negotiated arrangement.

Advantageously, retailers may use the present invention via negotiated agreements to further facilitate influencing consumer product selection decisions prior to a consumer making product selections, after a consumer has made a product selection, and in a manner which causes a related product or shopping activity to further be influenced at the consumer level. In practice, the present invention provides users, both consumer and retailers, with access to information that is of value and via a process in which the value of that access can be more fairly negotiated than would be the case where the collection is controlled from the outset by the retailer.

In general, the methods, software and routines executed to implement the embodiments of the invention, whether implemented as part of an operating system or a specific application, component, program, object, module or sequence of instructions will be and have been referred to herein as “computer programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media, such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in the accompanying figures are not intended to limit the present invention. Indeed, those skilled in the art will recognize that other alternative hardware and/or software environments may be used without departing from the scope of the invention.

For instance and by way of example, the necessity for a consumer to use a single local consumer media in which there are in effect at least two separate partitions, one for Private CII and at least one for Subset information, is not necessary to practice the present invention. In an alternative embodiment, a consumer may use one local consumer media source, such as a desktop hard drive, for his Private CII and create a second local consumer media which comprises only Subset information. In practice, the consumer would operationally be restricted when shopping as that information contained in the Subset and the extent to which such information could be made available to the retailer; i.e., the consumer would not be able to negotiate the access to or release of Private CII that was not otherwise contained in the Subset.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method for a retailer to permissively influence one or more shopping decisions of a consumer in a retail environment in cooperative exchange for certain consumer information, comprising:
setting forth consumer identifying information characteristics on a local consumer media device; storing a predetermined subset of said characteristics on said local consumer media device; communicating a conditional availability to access said subset to a retailer via an electronic communication, wherein said conditional availability is offered by said consumer prior to communicating the subset of characteristics; and,
negotiating to arrive at an acceptable set of access terms with the retailer whereby a mutually beneficial exchange is achieved.

2. The method of claim 1, wherein said consumer identifying information characteristics include at least one or more of: shopping history of consumer, product purchasing of consumer, retail environments said consumer has transacted with, shopping lists of consumer, product preferences of consumer, special interests of consumer, purchase-triggering dates of consumer, and financial information of consumer.

3. The method of claim 1, wherein said local consumer media device is one of a smart card, smart media, local storage within an electronically communication-enabled device, memory stick, flash memory, hard drive, software application, cell phone, or computer, and is capable of electronic communication with said retail environment.

4. The method of claim 2, wherein said predetermined subset of said characteristics comprises at least one of said consumer identifying information characteristics.

5. The method of claim 3, wherein said predetermined subset of said characteristics comprises at least one of said consumer identifying information characteristics.

6. The method of claim 5, further comprising the step of negotiating an acceptance of access of said subset to said retailer in exchange for a benefit to said consumer for said access.

7. The method of claim 6, wherein said benefit comprises one of: purchase savings, discounts, electronic coupons, related product purchase discounts, associated savings through affiliates of retailer, an incentive valued by said consumer.

8. The method of claim 7, further comprising the steps of said retailer accessing said subset and storing information obtained from said subset, and said consumer storing said benefit in said local consumer media device.

9. The method of claim 8, further comprising the step of said retailer relating said obtained information from said subset to affiliates or associates of retailer, directly or indirectly, in exchange for a benefit to said retailer.

10. The method of claim 8, further comprising the step of said consumer updating said consumer identifying information characteristics with recent transaction activities negotiated with retailer.

11. The method of claim 10, further comprising said consumer updating said predetermined subset to be accessible only under revised access rules.

12. A method for negotiating an electronic agreement between a retailer and a consumer having a local consumer media device, for a retailer's access to a predetermined set of consumer identifying information, the method comprising: electronically creating and storing on said local consumer media device consumer identifying information of the consumer; electronically creating and storing on said local consumer media device a first subset of predetermined consumer identifying information of the consumer; electronically associating said first subset of predetermined consumer identifying information with electronic permission terms, having negotiated offers of interest for consumer, for accessing said subset; and offering said subset to said retailer via communicating said permission terms for said retailer's acceptance or rejection; providing said retailer access to said subset where said retailer accepted said permission terms; and providing said consumer, via said local consumer media device, negotiated offers of interest as negotiated.

13. The method claim 12, wherein said local consumer media device is one of a smart card, smart media, local storage within an electronically communication-enabled device, memory stick, flash memory, hard drive, software application, cell phone, or computer, and is capable of communication with said retail environment.

14. The method of claim 13, further comprising a networked system of said retailer in communication with said local consumer media device.

15. The method of claim 14, further comprising negotiating between said local consumer media device and said networked system of said retailer consumer's offer of said subset to said retailer and iteratively modifying permission terms in relation to responses received from retailer.

16. The method of claim 15, further comprising the step of concluding said negotiating with a set of accepted or rejected negotiated terms as between the consumer and the retailer.

17. The method of claim 15, wherein said step of concluding being accepted and said set of negotiated terms being communicated to said consumer and said retailer, and further comprising the steps of providing access to said subset to said retailer, and providing said consumer with a benefit from said retailer, as negotiated.

18. The method of claim 17 wherein said benefit is assistance to said consumer during said consumer's shopping transaction to assist consumer in selecting an appropriate product for a particular need of said consumer.

19. A system for electronically negotiating an electronic agreement between a retailer and a consumer for a retailer's access to a predetermined set of consumer identifying information, comprising: a networked computer of a retailer, a local consumer media device capable of communication with a networked computer of retailer, a means for communication and sharing of data as between said local consumer media device and said networked computer of said retailer, wherein said consumer electronically creates and stores on said local consumer media device consumer identifying information; electronically creates and stores a first subset of predetermined consumer identifying information of the consumer on the local consumer media device; electronically associates said first subset of predetermined consumer identifying information with electronic permission terms defined by the consumer for accessing said subset; and offers said subset to said retailer via communicating said permission terms across said means of communications for said retailer's acceptance or rejection.

20. The system of claim 19, wherein said local consumer media device is a one of a smart card, smart media, local storage within an electronically communication-enabled device, memory stick, flash memory, hard drive, software application, cell phone, or computer, and is capable of communication with said retail environment
